(19) United States
(12) Patent Application Publication
(10) Pub. No.: US 2008/0212333 A1
(43) Pub. Date: Sep. 4, 2008

(54) Heat radiating device for lamp

(76) Inventor: Bor-Jang Chen, Pyng-Jenn City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/712,541

(22) Filed: Mar. 1, 2007

(51) Int. Cl. F21V 29/02

(52) U.S. Cl. 362/373

(57) ABSTRACT

The present invention relates to an improved heat radiating device for lamp, comprising an exhaust space configured around the periphery of lamp stand, an exhaust fan disposed at the top of exhaust space, and simultaneously a radiator and a plurality of heat conductors at the back of the printed circuit board of a light emitting diode (LED) lamp set where the heat conductors extend to the peripheral inner wall of lamp stand in the exhaust space. Through such a radiating device, high heat generated by the LED lamp set can be dissipated through the radiator and through the plurality of heat conductors to the periphery of lamp stand in the exhaust space, thereby enlarging the heat dissipation area. In addition, through the exhaust fan disposed at the top of the exhaust space, ventilation can take place continuously to let the heat in the exhaust space be vented rapidly, thereby achieving fast heat dissipation and prolonging the service life of LED lamp.

### BACKGROUND OF THE INVENTION

1. Field of the Invention

The present invention relates to an improved heat radiating device for lamp, more particularly, a heat radiating device for light emitting diode (LED) lamp that features high illuminating efficiency and low power consumption, characterized in which an exhaust space is configured around the periphery of lamp stand, an exhaust fan is disposed at the top of exhaust space to perform continuous ventilation, and a plurality of heat conductors are provided at the back of the printed circuit board of a light emitting diode (LED) lamp set that extend to the periphery of lamp stand in the exhaust space. As such, high heat generated by the LED lamp set can be rapidly conducted to the periphery of lamp stand, thereby enlarging the heat dissipation area. At the same time, heat dispersed in the exhaust space can be vented outside rapidly, thereby achieving fast heat dissipation and prolonging the service life of LED lamp.

2. Description of the Related Art

Most people undoubtedly favor lamps offering high illumination efficiency and lower power consumption. At the present time, light emitting diode (LED) lamps seem to have great potential, making it both popular and a trend for the future. But LED would generate large amount of heat while it illuminates. If the heat is not dissipated in time, it will accelerate the aging or even the failure of LED chip.

To address the problem, manufacturers commonly add heat radiating metal to achieve heat dissipation. This is done mainly by adhering a heat sink plate with fin design to the back of printed circuit board attached to the LED lamp set. Utilizing the enlarged heat dissipating area provided by the surfaces of the radiator fins, great amount of heat generated by the LED lamp set can be conducted to the heat sink, thereby increasing the rate of heat dissipation.

Without question, using a single heat sink adhered to the back of the LED lamp set does help enhance the heat dissipation efficiency of low-power LED. But for high-power LED that is gaining popularity, the current passing through it is much bigger than that in small-power LED. As a result, the heat generated is also significantly higher. Using the heat sink described above alone for heat dissipation purpose no longer meets the needs and results in poor performance of heat radiation.

### SUMMARY OF THE INVENTION

The primary object of the present invention is to provide an improved heat radiating device, characterized in which an exhaust space is configured around the periphery of lamp stand, an exhaust fan is disposed at the top of exhaust space to perform continuous ventilation, and a plurality of heat conductors are provided at the back of the printed circuit board of a light emitting diode (LED) lamp set that extend to the periphery of lamp stand in the exhaust space to enlarge the heat dissipation area. As such, high heat generated by the LED lamp set can be rapidly conducted to the periphery of lamp stand, thereby enhancing the heat dissipation efficiency. At the same time, heat dispersed in the exhaust space can be vented outside rapidly to achieve the effect of rapid heat dissipation.

Another object of the present invention is to provide a simple looking, easily made, convenient and unconventional improved heat radiating device for lamp that effectively enhances the heat dissipation efficiency of lamp, thereby prolonging its service life, and meeting the criteria of applicability, enablement, and inventive step.

The objects, features and functions of the present invention are illustrated in detail below with embodiments and accompanying drawings.

### BRIEF DESCRIPTION OF THE DRAWINGS

FIG. 1 is a front cutaway view according to an embodiment of the invention.

FIG. 2 is an aerial cutaway view of FIG. 1.

FIG. 3 is bottom view of FIG. 1.

FIG. 4 is an exploded structural view of FIG. 1.

### DETAILED DESCRIPTION OF THE PREFERRED EMBODIMENTS

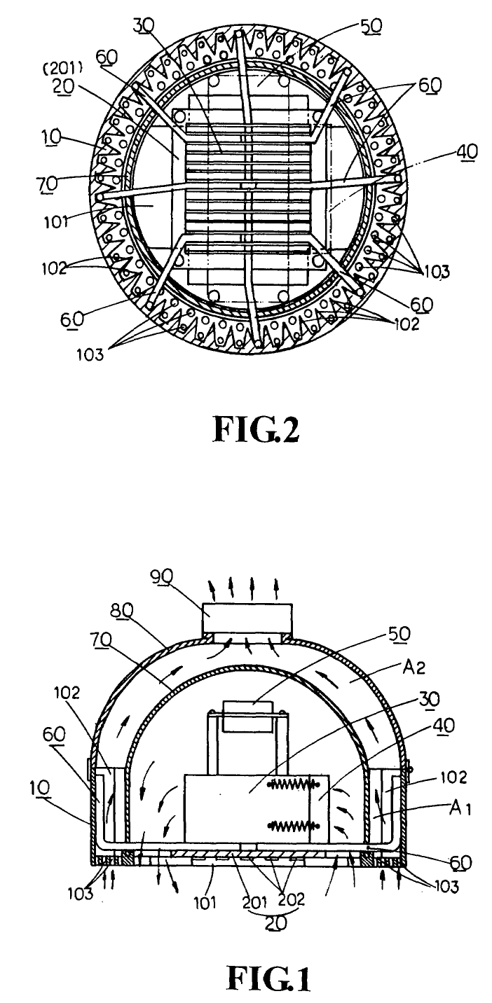

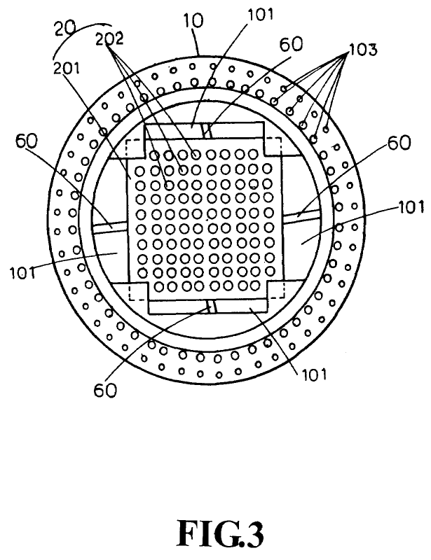

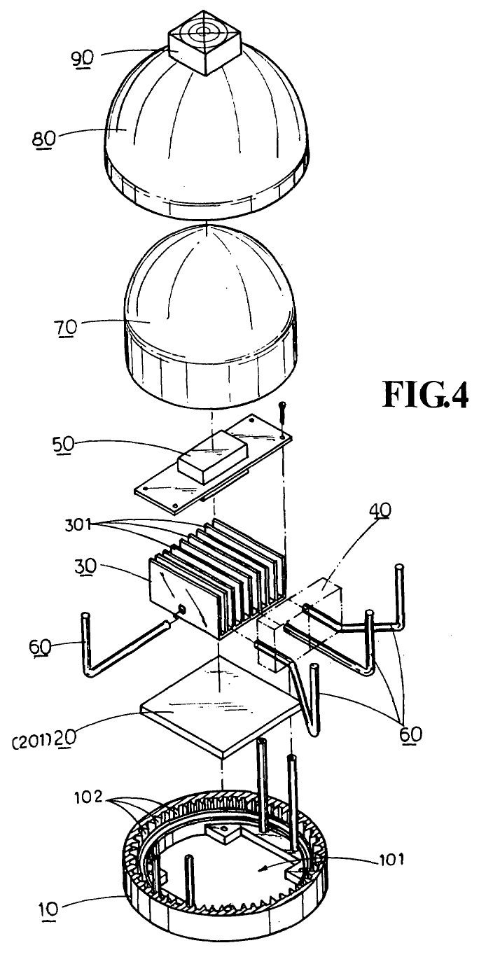

Referring to FIGS. 1˜4, the improved heat radiating device according to the invention comprises a lamp stand 10 in a generally concave shape and having a large perforated hole 101 at its bottom, disposed with a plurality of heat sinks 102 arranged along its peripheral inner wall, and provided with a plurality of through-going guide holes 103 near its bottom periphery; a light-emitting diode (LED) lamp set 20 arranged at the bottom of lamp stand 10 and provided with a printed circuit board 201 and a plurality of light emitting diodes 202 attached to the printed circuit board 201, the light emitting diodes corresponding exactly to the perforated hole 202 of lamp stand 20; a radiator 30 disposed at the back of printed circuit board 201 of LED lamp set and located inside the lamp stand 10, and provided with a plurality of radiator fins 301 capable of dissipating the heat generated by the LED lamp set 20; a first exhaust fan 40 arranged at one side of radiator 30 and able to discharge the heat absorbed and dispersed by the radiator 30 to enhance the heat dissipation efficiency; a power supply 50 embedded inside the lamp stand 10 and situated above the radiator 30 for power supply; a plurality of heat conductors 60, the heat absorbing ends of heat conductors being arranged respectively at the back of printed circuit board 201 in LED lamp set 20 or near the bottom of radiator 30, the respective heat transmitting ends of heat conductors being extendingly disposed on the peripheral inner wall of lamp stand 10 and able to rapidly conduct high heat generated by the LED lamp set 20 to the periphery of the entire lamp stand 10, the heat then being rapidly dissipated by the heat sinks 102; an inner shield 70 for covering the LED lamp set 20, radiator 30, first exhaust fan, and power supply 50, and forming a first exhaust space A1 with the periphery of lamp stand 10 that contains the heat conductor 60, the first exhaust space A1 communicating with the through-going guide holes 103 at the bottom periphery of lamp stand 10; an outer shield 80 mounted at the top of lamp stand 10 and forming a second exhaust space A2 with the inner shield 70, the second exhaust space A2 communicating with the first exhaust space A1 situated between the lamp stand 10 and inner shield 70; a second exhaust fan 90 installed at the top of outer shield 80 and communicating with the second exhaust space A2.

With the heat absorbing ends of a plurality of heat conductors 60 installed at the back of printed circuit board 201 of LED lamp set 20, and the heat transmitting ends of heat conductors 60 extending to the peripheral inner wall of lamp stand 10, high heat generated by the LED lamp set 20 can be directly and rapidly transferred to the entire periphery of lamp stand 10. Also, as the plurality of fin-shaped heat sinks 102 arranged around the periphery of lamp stand 10 enlarge the heat dissipation area, and the heat sinks 102 and the heat conductors 60 are contained in the first exhaust space A1, high heat transferred to the periphery of lamp stand 10 can also be rapidly dissipated to the entire first exhaust space A1. In addition, the second exhaust space A2 formed between outer shield 80 and inner shield 70 communicates directly with the first exhaust space A1, and the second exhaust fan 90 mounted at the top of outer shield 80 can continuously perform ventilation. Thus heat dispersed in the first exhaust space A1 can be rapidly vented outside through the second exhaust space A2, thereby enhancing the heat dissipation efficiency. Of course, because the plurality of through-going guide holes 103 disposed at the bottom periphery of lamp stand 10 face the first exhaust space A1, when the second exhaust fan 90 discharges the heat in the second exhaust space A2 and first exhaust space A1, fresh air enters the first exhaust space A1 through the through-going guide holes 103. Naturally, under the smooth convection of air, the heat dissipated from the plurality of heat sinks 102 of lamp stand 10 is more rapidly vented, thereby achieving high heat dissipation efficiency.

As described above, the inner shield 70 covers LED lamp set 20, radiator 30, first exhaust fan, and power supply 50, and the plurality of through-going guide holes 103 disposed at the bottom periphery of lamp stand 10 face the first exhaust space A1 and second exhaust space A2. Thus when it rains and the lamp set of the invention is placed outdoor, water seeping in from the second exhaust fan 90 will drip smoothly downward along the outer edge of inner shield 70 and be discharged from the through-going guide holes 103 without having to worry about the parts inside the inner shield being wetted and/or damaged.

As described above, a radiator 30 and a first exhaust fan 40 are mounted at the back of LED lamp set 20. Thus the heat generated from the LED lamp set 20 can also be dissipated through the plurality of radiator fins 301 of radiator 30 in addition to through the heat conductor 60 to the periphery of lamp stand 10 where large area and high effeminacy heat dissipation takes place. Of course, through the forced convection of first exhaust fan 40, the heat dissipated from radiator 30 can be discharged more rapidly from the perforated hole 101 at the periphery of LED lamp set 20, thereby enhancing the heat dissipation efficiency.

As described above, to boost the heat dissipation efficiency of LED lamp set 20, the heat absorbing ends and heat transmitting ends of heat conductors 60 are preferably evenly distributed at the back of printed circuit board 20 of LED lamp set 20 and the periphery of lamp stand 10.

What is claimed is:

1. An improved heat radiating device for lamp, comprising: a lamp stand in generally concave shape and configured with a large perforated hole at its bottom; a light emitting diode (LED) lamp set mounted at the bottom of lamp stand and having a printed circuit board and a plurality of light emitting diodes attached to the printed circuit board, the light emitting diodes being corresponding exactly to the position of perforated hole of lamp stand; a radiator arranged at the back of printed circuit board of LED lamp set and inside the lamp stand, and having a plurality of radiator fins; a first exhaust fan disposed at one side of radiator; and a power supply arranged inside the lamp stand and above the radiator;
characterized in which: the peripheral inner wall of lamp stand is provided with a plurality of fin-shaped heat sinks and a plurality of through-going guide holes near the bottom periphery; the back of the printed circuit board of LED lamp set is disposed with the heat absorbing ends of a plurality of heat conductors, the respective heat transmitting ends of heat conductors being extendingly disposed on the peripheral inner wall of lamp stand; an inner shield is disposed inside the lamp stand for covering the LED lamp set, radiator, first exhaust fan, and power supply, and forming a first exhaust space with the periphery of lamp stand that contains the heat transmitting ends of heat conductors, the first exhaust space communicating with the through-going guide holes at the bottom periphery of lamp stand; an outer shield mounted at the top of lamp stand and forming a second exhaust space with the inner shield, the second exhaust space communicating with the first exhaust space; a second exhaust fan is installed at the top of outer shield and able to vent the air in first exhaust space and second exhaust space.

2. An improved heat radiating device as claimed in claim 1, wherein said heat absorbing ends and heat transmitting ends of heat conductor are preferably evenly distributed at the back of printed circuit board of LED lamp set and the periphery of lamp stand.

3. An improved heat radiating device for lamp, comprising: a lamp stand in generally concave shape and configured with a large perforated hole at its bottom; a light emitting diode (LED) lamp set mounted at the bottom of lamp stand and having a printed circuit board and a plurality of light emitting diodes attached to the printed circuit board, the light emitting diodes being corresponding exactly to the position of perforated hole of lamp stand; a radiator arranged at the back of printed circuit board of LED lamp set and inside the lamp stand, and having a plurality of radiator fins; a first exhaust fan disposed at one side of radiator; and a power supply arranged inside the lamp stand and above the radiator; characterized in which:
the peripheral inner wall of lamp stand is provided with a plurality of fin-shaped heat sinks and a plurality of through-going guide holes near the bottom periphery; the back of the LED lamp set near the bottom of radiator is disposed with the heat absorbing ends of a plurality of heat conductors, the respective heat transmitting ends of heat conductors being extendingly disposed on the peripheral inner wall of lamp stand; an inner shield is disposed inside the lamp stand for covering the LED lamp set, radiator, first exhaust fan, and power supply, and forming a first exhaust space with the periphery of lamp stand that contains the heat transmitting ends of heat conductors, the first exhaust space communicating with the through-going guide holes at the bottom periphery of lamp stand; an outer shield mounted at the top of lamp stand and forming a second exhaust space with the inner shield, the second exhaust space communicating with the first exhaust space; a second exhaust fan is installed at the top of outer shield and able to vent the air in first exhaust space and second exhaust space.

4. An improved heat radiating device as claimed in claim 3, wherein said heat absorbing ends and heat transmitting ends of heat conductor are preferably evenly distributed at the back of LED lamp set near the bottom of radiator and the periphery of lamp stand.
